(19) United States
(12) Patent Application Publication
(10) Pub. No.: US 2026/0073458 A1
(43) Pub. Date: Mar. 12, 2026

(54) System and Method for Optimizing Fuel Usage and Tax Refunds in Long-Haul Trucking Operations

(71) Applicant: Sergio Morales Sosa, Casper, WY (US)

(72) Inventor: Sergio Morales Sosa, Casper, WY (US)

(21) Appl. No.: 18/827,804

(22) Filed: Sep. 8, 2024

(51) Int. Cl. G06Q 50/06; G06Q 10/0835; G06Q 30/0234

(52) U.S. Cl. CPC G06Q 50/06; G06Q 10/08355; G06Q 30/0234

(57) ABSTRACT

The present invention relates to a computer-implemented method, system, and computer-readable medium for optimizing fuel usage and maximizing tax refunds in long-haul trucking operations. The invention receives route data, retrieves fueling station information, and recursively analyzes the route to generate fueling recommendations that minimize unburdened fuel costs. The invention collects trip details to automatically generate an International Fuel Tax Agreement (IFTA) report, facilitating refund acquisition. The system may integrate with existing fleet management systems and select fueling stations based on real-time prices and historical trends. User interfaces display real-time alerts and detailed savings reports. By recursively analyzing routes and generating optimal fueling recommendations, the invention reduces fuel expenses, maximizes tax rebates, and improves operational efficiency for trucking companies.

### BACKGROUND OF THE INVENTION

### Field of Invention

The present invention relates to the field of transportation and logistics, particularly to systems and methods for optimizing fuel efficiency and maximizing tax rebates for long-haul trucking operations.

### Description of Related Art

Various fuel optimization and tax compliance solutions exist in the trucking industry. However, these existing systems suffer from certain limitations and disadvantages. Many fail to provide real-time, location-based fuel price comparisons, leading to higher fuel expenses for truckers. Additionally, traditional methods for International Fuel Tax Agreement (IFTA) filing are often manual, time-consuming, and prone to errors, resulting in unexpected tax liabilities, additional charges, and increased audit risk.

Furthermore, current solutions often lack personalization, failing to offer tailored fueling recommendations based on specific routes and fuel price data. Integration issues also persist, as many systems do not seamlessly integrate with existing fleet management platforms, leading to inefficiencies and data silos.

Accordingly, there is a need for an improved system that optimizes fuel efficiency, maximizes tax rebates, and addresses the limitations of existing solutions in the long-haul trucking industry. Such a system would provide real-time data analysis, automated tax filing, personalized recommendations, and seamless integration capabilities to enhance overall operational efficiency and profitability for truckers.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present invention provides a computer-implemented method, system, and computer-readable medium for optimizing fuel usage and maximizing tax refunds in long-haul trucking operations. In one aspect, the invention receives route data indicating a starting point and final destination, retrieves a list of fueling stations with locations and prices along the route, and recursively analyzes the route to generate fueling recommendations. The analysis determines if a leg can be completed with the current fuel level and, if not, identifies an intermediate station with the lowest unburdened fuel cost. The fueling recommendations, indicating the quantity of fuel to purchase at each stop, are transmitted to a driver device.

Advantageously, the present invention collects trip details including miles driven, fuel purchased, and prices in each jurisdiction traversed, using this data to automatically generate an International Fuel Tax Agreement (IFTA) report. This facilitates obtaining IFTA refunds while reducing manual effort and errors. In a preferred embodiment, the invention further optimizes fuel efficiency by determining an optimal speed for each leg based on route data and fuel prices, transmitting this to the driver.

The invention may integrate with existing fleet management systems, accessing driver, vehicle, and route data to provide seamless, personalized recommendations. Fueling stations are selected from a database of real-time prices and historical trends. The recursive route analysis discards stations that are less than a minimum distance from the leg start or require less than a minimum fuel purchase, considering factors like the truck's MPG, fuel tank size, current fuel level, and desired reserve amount.

The target fueling quantity optimizes costs across multiple jurisdictions. User interfaces display real-time alerts to the driver and detailed savings reports to fleet managers. In one embodiment, the next intermediate station is determined by selecting the lowest unburdened cost within a maximum distance from the current stop. By recursively analyzing routes and generating optimal fueling recommendations, the present invention reduces fuel expenses, maximizes tax rebates, and improves operational efficiency for trucking companies. These and other features and advantages of the invention will be apparent from the following detailed description of preferred embodiments.

Additional features and advantages of the invention will be set forth in the description which follows. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a schematic block diagram illustrating an exemplary fuel optimization system for long-haul trucking according to the present invention.

FIG. 2 illustrates an embodiment of a user interface (UI) configured for a fleet manager device within the fuel optimization system.

FIG. 3 illustrates an embodiment of a user interface (UI) for a driver device within the fuel optimization system, according to one embodiment

FIG. 4 is a flow diagram detailing the steps and backend processes of the system.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

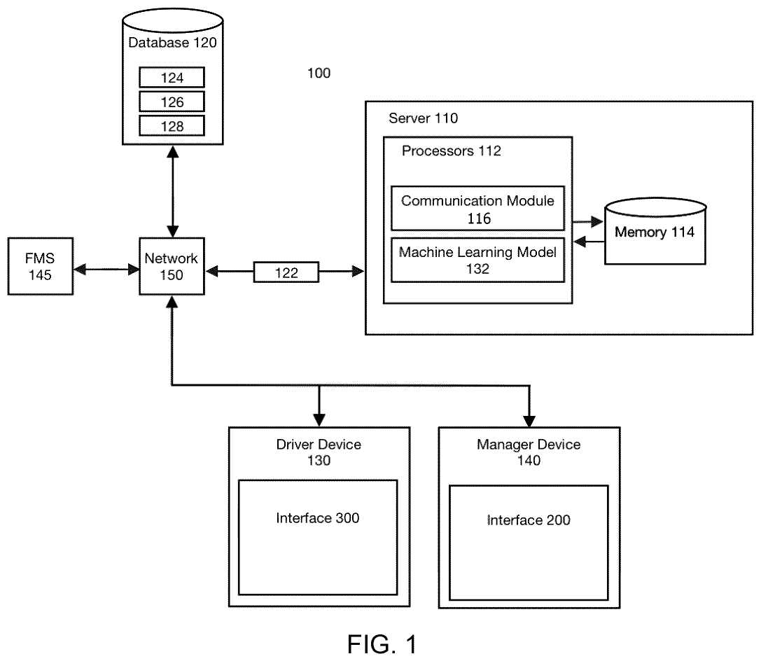

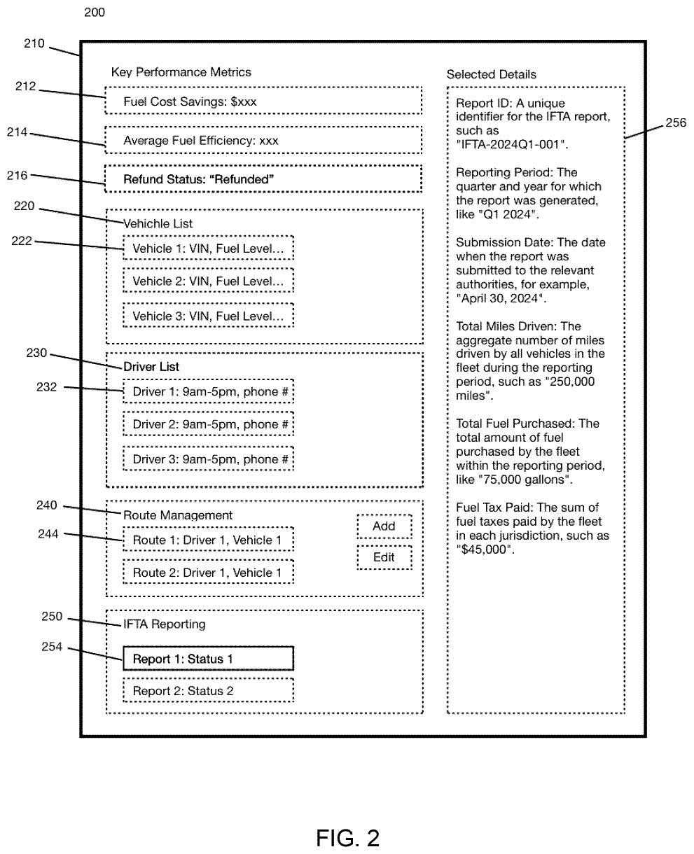

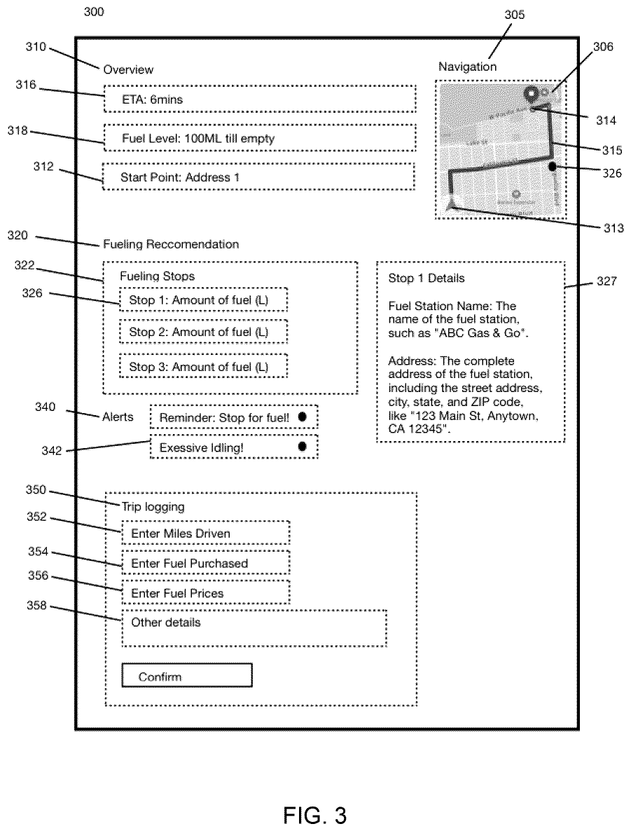

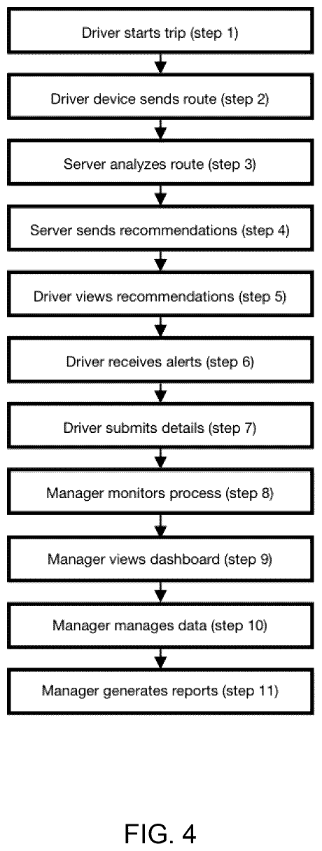

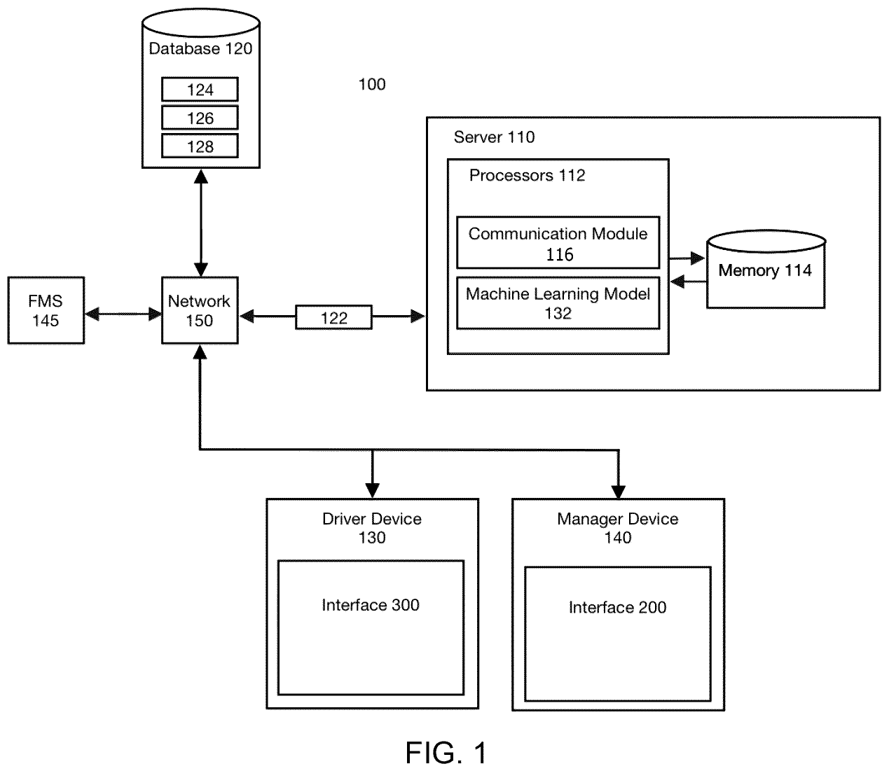

FIG. 1 is a schematic block diagram illustrating an exemplary fuel optimization system 100 for long-haul trucking according to the present invention. As shown in FIG. 1, the system 100 comprises a fuel optimization server 110, a database 120, a driver device 130, a fleet manager device 140, and a network 150.

In one embodiment, the fuel optimization server 110 includes one or more processors 112 coupled to a memory 114. The processors 112 may include, but are not limited to, general-purpose microprocessors, application-specific integrated circuits (ASICs), field-programmable gate arrays (FPGAs), or any other suitable processing devices. The memory 114 may comprise volatile memory, such as random access memory (RAM), and/or non-volatile memory, such as read-only memory (ROM), flash memory, or magnetic or optical storage devices. The memory 114 stores computer-executable instructions that, when executed by the processors 112, cause the server 110 to perform fuel optimization operations, such as determining optimal fueling locations and quantities based on factors comprising route data 122, fueling station data 124, driver data 126, and vehicle data 128 stored in the database 120. In the illustrated embodiment, the server 110 communicates with the database 120, the driver device 130, and the fleet manager device 140 via a communication module 120, which may utilize various wired or wireless communication technologies including, but not limited to, cellular networks (e.g., 4G LTE, 5G), satellite communication, or the Internet (e.g., TCP/IP).

The database 120 is configured to store route data 122 indicating a starting point and a final destination for a long-haul trucking route, along with intermediate waypoints and estimated travel times between each waypoint. In another embodiment, the database 120 also stores fueling station data 124 including but not limited to locations, fuel prices, available fuel types (e.g., diesel, gasoline, compressed natural gas), and amenities (e.g., restrooms, restaurants, parking) for fueling stations along the route. Optionally, in some embodiments, the database 120 may further store driver data 126 indicating available hours of service for a driver based on electronic logging device (ELD) data and regulations such as the Federal Motor Carrier Safety Administration's (FMCSA) hours of service rules. Additionally, the database 120 may store vehicle data 128 indicating a current load of a vehicle, fuel efficiency at various loads and speeds, and fuel tank capacity.

In the illustrated embodiment, the driver device 130 is a computing device, such as, by way of example and not limitation, a smartphone, tablet, or in-vehicle computer, that receives fueling recommendations and real-time alerts from the fuel optimization server 110 via a mobile application or web interface. The fueling recommendations may include the optimal locations, prices, and quantities of fuel to purchase along the route based on the route data 122, fueling station data 124, driver data 126, and vehicle data 128. In one embodiment, the real-time alerts may include notifications of changes in fuel prices, traffic conditions, or weather that affect the optimal fueling strategy. Optionally, the driver device 130 may also transmit data to the server 110, including but limited to the current fuel level of the vehicle obtained from a fuel sensor or telematics device, or trip details entered manually by the driver.

As depicted in FIG. 1, the fleet manager device 140 is a computing device, such as a desktop computer or laptop, that receives reports generated by the fuel optimization server 110, including, but not limited to, an International Fuel Tax Agreement (IFTA) report detailing the miles driven and fuel purchased in each jurisdiction. In another embodiment, the fleet manager device 140 may also receive other reports, such as fuel cost savings reports comparing the optimized fueling strategy to a baseline strategy, or driver performance reports indicating compliance with the optimized fueling recommendations. The fleet manager device 140 includes a user interface 200 that displays the reports and allows the fleet manager to interact with the fuel optimization system.

In one embodiment, the reports comprise an International Fuel Tax Agreement (IFTA) report detailing the miles driven and fuel purchased in each jurisdiction. In another embodiment, the fleet manager device 140 may also receive other reports, including but not limited to fuel cost savings reports comparing the optimized fueling strategy to a baseline strategy, or driver performance reports indicating compliance with the optimized fueling recommendations. The driver device 130 includes a user interface 300 that displays the optimized fueling recommendations and allows the driver to input fuel purchase information and interact with the fuel optimization system.

As illustrated in FIG. 1, the network 150 is configured to facilitate information transmission between the fuel optimization server 110, the database 120, the driver device 130, and the fleet manager device 140 using standard communication protocols such as HTTP, HTTPS, FTP, or SFTP. In one embodiment, the network 150 may be the Internet, a virtual private network (VPN), a local area network (LAN), a wide area network (WAN), or any other suitable wired or wireless communication network, such as a cellular network or a satellite network.

According to an embodiment, the fuel optimization server 110 is configured to receive route data 122 from the database 120 or the driver device 130 via the network 150. The route data 122 may be obtained from a transportation management system (TMS), a global positioning system (GPS) device, or manually entered by the driver or fleet manager. As shown in FIG. 1, the processors 112 are configured to retrieve fueling station data 124 from the database 120, wherein the fueling station data 124 may be obtained from third-party fuel price aggregators or directly from the fueling stations via application programming interfaces (APIs) or web scraping techniques. The processors 112 are further configured to recursively analyze the route to determine an optimal fueling strategy using dynamic programming algorithms, such as Dijkstra's algorithm or the Bellman-Ford algorithm, to minimize the total cost of fuel for the route.

In another embodiment, the fuel optimization server 110 employs machine learning techniques to enhance the accuracy and efficiency of the fuel optimization process. The processors 112 are configured to train a machine learning model 132, such as a deep neural network or a gradient boosting model, using historical route data, fuel prices, and driver behavior data stored in the database 120. The trained machine learning model 132 is then used to predict fuel prices at different locations and times, as well as to estimate the fuel efficiency of the vehicle based on factors such as the vehicle's load, speed, and driving conditions. These predictions are fed into the dynamic programming algorithms to determine the optimal fueling strategy for the given route. The machine learning model 132 is continuously updated with new data from completed trips to improve its accuracy over time. Additionally, the machine learning model 132 can be used to provide personalized fueling recommendations for each driver based on their individual driving patterns and preferences, which are displayed on the user interface 300 of the driver device 130.

In one embodiment, the recursive analysis involves determining if a leg of the route can be completed with the current fuel level, taking into account factors such as the vehicle's fuel efficiency, terrain, and weather conditions. If the leg cannot be completed, the processors 112 are configured to identify an intermediate fueling station with the lowest unburdened fuel cost, i.e., the fuel price. The fuel price calculated in this process can factor in various variables including but not limited to fuel price minus discount on fuel (if applicable), fuel taxes, federal excise taxes, state excise taxes, or sales taxes. The processors 112 then generate a fueling recommendation indicating the quantity of fuel to purchase at the identified station, based on factors comprising, the weight of the load carried by the vehicle, the vehicle's fuel tank capacity, the distance to the next fueling opportunity, and any applicable discount programs or loyalty rewards. This process is repeated for each leg of the route until the final destination is reached, using techniques such as memorization or tabulation to avoid redundant calculations. This fueling recommendation is displayed to the driver via the user interface 300 on the driver device 130. The user interface 300 allows the driver to view the recommended fueling station, the suggested fuel quantity, and any additional information related to the fueling recommendation.

To optimize the fueling strategy, the processors 112 may consider additional factors including but not limited to:
discarding fueling stations less than a minimum distance from the starting point of a leg, based on user-defined preferences or industry best practices; discarding fueling stations that require less than a minimum amount of fuel to reach, based on the vehicle's fuel efficiency and fuel tank capacity;
determining an optimal driving speed for each leg, using techniques such as linear programming or calculus of variations;
maintaining a desired reserve fuel amount, based on regulatory requirements or company policies;
real-time changes in road and weather conditions obtained via APIs or web sockets;
real-time changes in fuel prices, obtained via APIs or web sockets; and driver hours of service and vehicle load data, obtained from electronic logging devices (ELDs) or onboard sensors.

Based on the detailed description provided herein, a skilled artisan would be able to re-create the claimed invention without undue experimentation. The examples above describe the key aspects of the invention in sufficient detail to allow a person having ordinary skill in the field of fleet management and fuel optimization to make and use the invention.

As shown in FIG. 1, the communication module 116 is configured to transmit the generated fueling recommendation to the driver device 130 via the network 150, using push notifications, SMS messages, or in-app alerts. In one embodiment, the communication module 116 also transmits real-time alerts indicating when to stop at the recommended fueling stations, based on the vehicle's current location and fuel level. The driver device 130 presents this information to the driver via a user interface, which may include, but is not limited to, maps, directions, and estimated arrival times.

Throughout the trip, the driver device 130 collects trip details such as miles driven, fuel purchased, and fuel prices in each jurisdiction, using GPS tracking, manual input, or integration with fuel card providers or point-of-sale systems. In the illustrated embodiment, this data is transmitted to the fuel optimization server 110 via the network 150, using secure communication protocols such as HTTPS or SSL/TLS. The fuel optimization server 110 is configured to generate an IFTA report to facilitate obtaining fuel tax refunds, using the collected trip details and the applicable tax rates for each jurisdiction. In one embodiment, the IFTA report is then sent to the fleet manager device 140 via the network 150 for further processing, such as submitting the report to the relevant tax authorities or integrating the data with accounting systems.

In some embodiments, the fuel optimization system 100 may be integrated with an existing fleet management system (FMS) 145, such as, by way of example and not limitation, a transportation management system (TMS), a maintenance management system (MMS), or a driver performance monitoring system, to access additional data sources and provide a unified interface for drivers and fleet managers. This integration may be achieved through APIs, web services, or data import/export functionality.

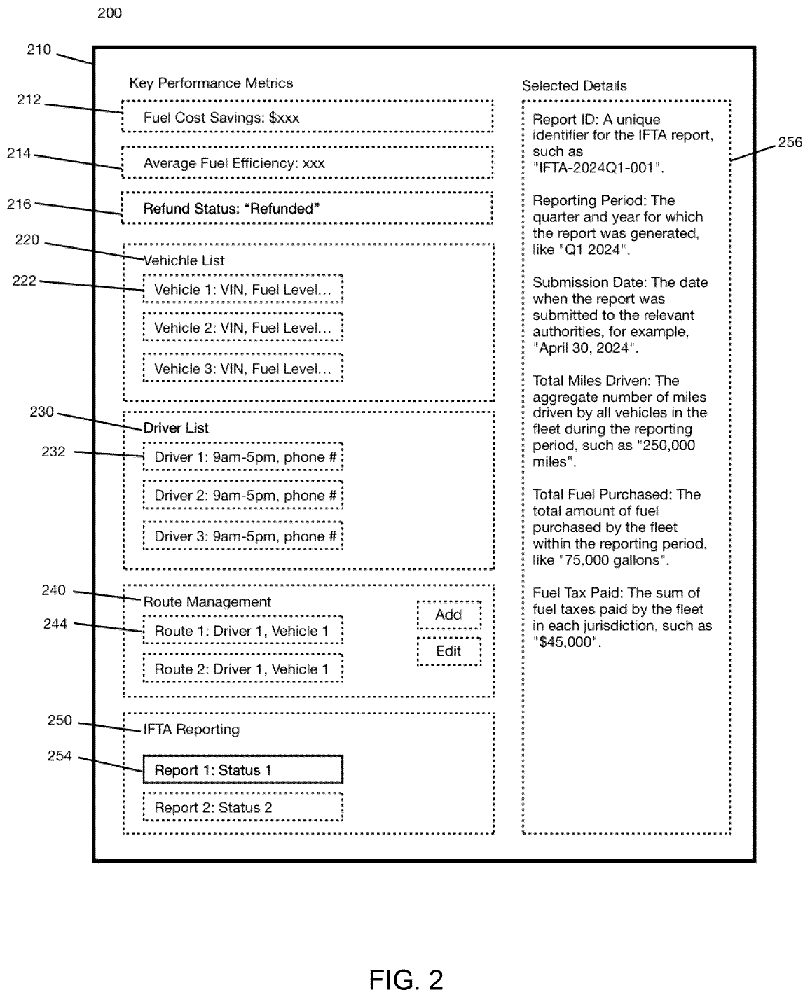

FIG. 2 illustrates an embodiment of a user interface (UI) 200 configured for a fleet manager device 140 within the fuel optimization system 100. In one embodiment, this UI 200 enables fleet managers to effectively monitor and manage the fuel optimization process across multiple vehicles and drivers.

As shown in FIG. 2, the UI 200 comprises a comprehensive dashboard 210 that presents an overview of crucial performance metrics, including total fuel cost savings 212, average fuel efficiency 214, and IFTA refund status 216. In another embodiment (not depicted), the dashboard 210 may also incorporate visual representations of data, such as graphs or charts, thereby facilitating the fleet manager's ability to swiftly identify trends and areas requiring improvement.

Depicted in FIG. 2 is a vehicle list 220 that offers a concise summary of all vehicles managed by the fuel optimization system 100. In one embodiment, each vehicle entry 222 may encompass information like the vehicle identification number (VIN), current location, fuel level, and assigned driver. Optionally, fleet managers can select a specific vehicle entry 222 to access more detailed information about that particular vehicle.

The UI 200 in FIG. 2 further comprises a driver list 230 that exhibits a summary of all drivers associated with the managed vehicles. According to an embodiment, each driver entry 232 may include the driver's name, contact information, available hours of service, and current vehicle assignment. Fleet managers can select a driver entry 232 to view more detailed information about that specific driver, such as their driving history and fuel optimization performance.

A route management section 240 in FIG. 2 is configured to enable fleet managers to view, edit, and create routes for the managed vehicles. In the illustrated embodiment, this section may include a route list displaying all active and upcoming routes, along with their associated vehicles and drivers. Fleet managers can select a route entry 244 to view more details about the route, such as the starting point, final destination, and planned fueling stops.

As illustrated in FIG. 2, an IFTA reporting section 250 is provided to streamline the generation and submission of IFTA reports for obtaining fuel tax refunds. This section may include a report list displaying all previously generated reports and their submission status. Fleet managers can select a report entry 254 to view the full report details and submit the report to the appropriate authorities.

In one embodiment (not shown), a settings section allows fleet managers to configure various aspects of the fuel optimization system 100, such as integrating with existing fleet management systems, setting default fuel optimization parameters, and managing user accounts and permissions.

In the UI 200 shown in FIG. 2, whatever part of the UI is currently selected, the details that are associated appear in the selected details section 256. In this embodiment, as illustrated, the report status 1 (254) is selected from the IFTA reporting section 250 and the corresponding details for report status 1 are displayed in the selected details section.

The UI 200 in FIG. 2 is coupled to the fuel optimization server 110 via the network 150, wherein the UI 200 and the server 110 exchange data and commands related to fuel optimization operations. In an embodiment, the UI 200 may be implemented using various web technologies, such as HTML, CSS, and JavaScript, and may be accessible through a standard web browser disposed on the fleet manager device 140.

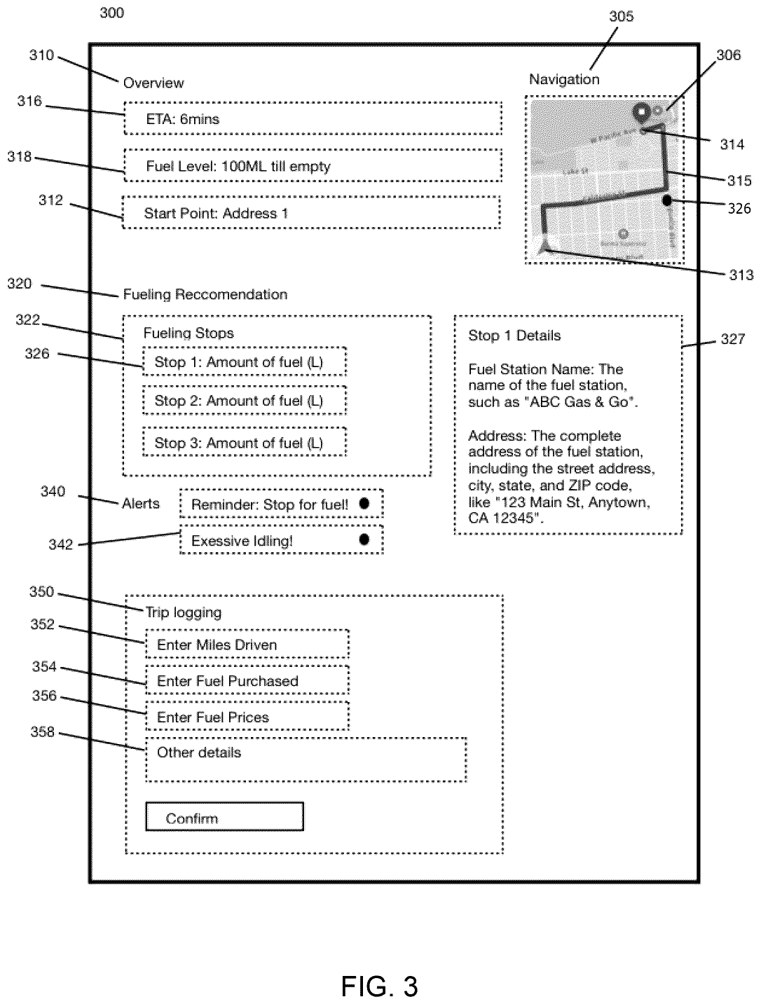

FIG. 3 illustrates an embodiment of a user interface (UI) 300 for a driver device 130 within the fuel optimization system 100, according to one embodiment. The UI 300 is configured to provide drivers with real-time fueling recommendations, alerts, and trip information, thereby helping them to optimize fuel usage and comply with IFTA requirements.

As shown in FIG. 3, the UI 300 comprises a trip overview section 310 that displays key information about the driver's current trip, such as the estimated time of arrival (ETA) 316, and the starting point 312. In the illustrated embodiment, this section may also show the current vehicle fuel level 318 and the distance remaining until the next recommended fueling stop.

The UI 300 further includes a navigation section 305 that provides turn-by-turn directions to guide the driver along the optimized route. In one embodiment, the navigation section 305 displays a map 306 depicting the current vehicle location 313, the route 315, the final destination 314, and one or more recommended fueling stops 326. Optionally, the navigation section 305 may also provide voice prompts (not depicted) to alert the driver of upcoming turns, fueling stops, or other events.

A fueling recommendation section 320 is configured to present the driver with the optimal fueling strategy generated by the fuel optimization server 110. In the illustrated embodiment, the fueling recommendation section 320 includes a list of recommended fueling stops 322. The UI 300 is configured to allow drivers to select a fueling stop entry 326 to view additional details 327 about the stop, including but not limited to fuel price, the recommended quantity of fuel to purchase at each stop, distance from the current location, and estimated time of arrival.

The UI 300 further comprises an alerts section 340 that displays real-time notifications and reminders, thereby helping the driver stay on track and comply with fuel optimization and IFTA requirements. Alerts 342 may include, but are not limited to, reminders to stop at a recommended fueling station, warnings about low fuel levels or excessive idling, and prompts to record trip details for IFTA reporting.

In another embodiment, the UI 300 includes a trip logging section 350 that enables the driver to easily record and submit trip details required for IFTA reporting. The trip logging section 350 may include fields for entering information such as miles driven 352, fuel purchased 354, and fuel prices 356 for each jurisdiction traversed during the trip. The UI 300 is configured to allow drivers to submit the trip details 358 to the fuel optimization server 110 for processing and IFTA report generation.

Optionally, the UI 300 may include a settings section (not shown) that enables drivers to customize various aspects of the UI 300, such as setting preferences for alert notifications, adjusting the map display, and managing their driver profile information.

As illustrated in FIG. 3, the UI 300 is configured to communicate with the fuel optimization server 110 via the network 150 to exchange data and commands related to fuel optimization operations. In one embodiment, the UI 300 may be implemented as a native mobile application for smartphones or tablets. Alternatively, the UI 300 may be implemented as a web-based application accessible through a mobile web browser on the driver device 130.

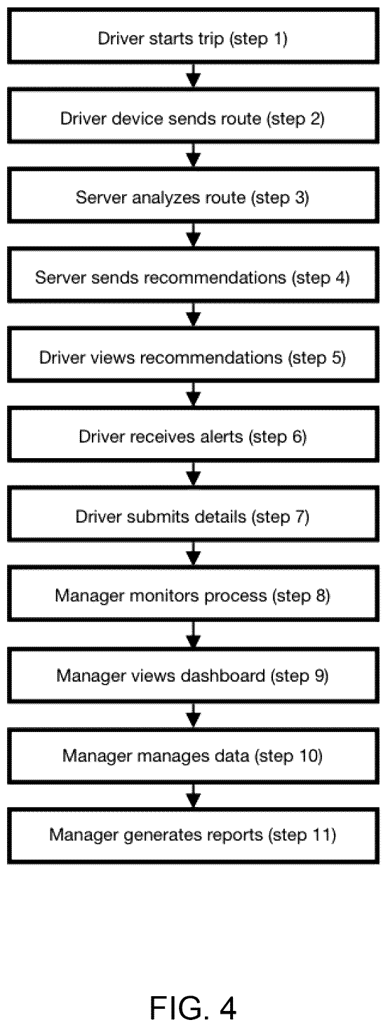

FIG. 4 is a flow diagram detailing the steps and backend processes of the system. With reference to FIG. 3, in one embodiment, the driver, using the driver device (130), begins a trip by entering the starting point (312) and final destination (314) into the navigation section (305) of the user interface (UI) (300) (step 1). In the illustrated embodiment, the driver device (130) is configured to transmit the route data to the fuel optimization server (110) via the network (150) (step 2).

In one embodiment, the processors (112) disposed in the fuel optimization server (110) are configured to recursively analyze the route using dynamic programming algorithms to determine the optimal fueling strategy, wherein said strategy considers factors including but not limited to vehicle fuel efficiency, terrain, weather conditions, and driver hours of service (step 3).

According to an embodiment, the fuel optimization server (110) sends the optimized fueling recommendations, including recommended fueling stops (322) and quantities to the driver device (130) via the network (150) (step 4). As shown in FIG. 3, the driver device (130) is configured to display the fueling recommendations in the fueling recommendation section (320) of the UI (300), along with the trip overview (310) and navigation information (305) (step 5).

In another embodiment, during the trip, the driver receives real-time alerts (342) in the alerts section (340) of the UI (300), prompting them to stop at recommended fueling stations (318) and record trip details for IFTA reporting (step 6). As illustrated in FIG. 1, the communication module (120) disposed in the fuel optimization server (110) is configured to transmit the generated fueling recommendations and real-time alerts to the driver device (130) via the network (150).

The driver records trip details, such as, by way of example and not limitation, miles driven (352), fuel purchased (354), and fuel prices (356), in the trip logging section (350) of the UI (300) and submits the data (358) to the fuel optimization server (110) via the network (150) (step 7). In one embodiment, the fuel optimization server (110) receives trip details from the driver device (130), processes the data, and generates IFTA reports, wherein said reports are sent to the fleet manager device (140) via the network (150).

With reference to FIG. 2, in the illustrated embodiment, the fleet manager, using the fleet manager device (140), accesses the user interface (UI) (200) to monitor and manage the fuel optimization process for multiple vehicles and drivers (step 8). As depicted in FIG. 2, the fleet manager views the dashboard (210) to see an overview of key performance metrics including but not limited to total fuel cost savings (212), average fuel efficiency (214), and IFTA refund status (216) (step 9).

In one embodiment, the fleet manager can view and manage the vehicle list (220), driver list (230), and route management section (240) to access detailed information about specific vehicles, drivers, and routes (step 10). According to an embodiment, the fleet manager generates and submits IFTA reports using the IFTA reporting section (250) of the UI (200), wherein said UI (200) communicates with the fuel optimization server (110) via the network (150) (step 11).

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A computer-implemented method for optimizing fuel usage and maximizing tax refunds for long-haul trucking, the method comprising:
receiving, at a server, route data indicating a starting point and a final destination for a long-haul trucking route;
retrieving, from a database, a list of fueling stations along the route, each fueling station associated with a location and a fuel price;
recursively analyzing, using one or more processors operatively coupled to a memory, the route by:
1. determining if a leg of the route can be completed with a current fuel level;
2. if the leg cannot be completed, identifying an intermediate fueling station with a lowest unburdened fuel cost, the unburdened fuel cost excluding one or more taxes and one or more discounts;
3. generating a fueling recommendation indicating a quantity of fuel to purchase at the intermediate fueling station;
transmitting the fueling recommendation to a driver device;
collecting trip details associated with the route; and
generating an International Fuel Tax Agreement (IFTA) report based on the trip details to facilitate obtaining an IFTA refund.

2. The method of claim 1, further comprising:
determining an optimal driving speed for each leg of the route based on factors comprising road conditions, route data, and the fuel prices at the identified intermediate fueling stations; and
transmitting the optimal driving speed to the driver device to further optimize fuel usage.

3. The method of claim 1, wherein the trip details include miles driven, fuel purchased, and fuel prices in each jurisdiction traversed during the route.

4. The method of claim 1, further comprising integrating the method with an existing fleet management system to access driver, vehicle, and route data.

5. The method of claim 1, wherein the list of fueling stations is retrieved from the database based on real-time fuel price data and historical fuel price trends.

6. The method of claim 1, wherein recursively analyzing the route further comprises:
determining a target fueling station by discarding stations that are less than a minimum distance from a starting point of a leg or require less than a minimum amount of fuel to reach from the starting point.

7. The method of claim 1, further comprising:
receiving, at the server, a truck miles per gallon (MPG) value, a fuel tank size, a current fuel level, and a desired reserve fuel amount; and
using the received data as input parameters for recursively analyzing the route.

8. The method of claim 1, wherein the fueling recommendation includes a target quantity of fuel to purchase at each identified intermediate fueling station to optimize fuel costs across multiple jurisdictions.

9. The method of claim 1, further comprising generating user interfaces for:
displaying real-time fueling recommendations and alerts to a driver via the driver device; and
presenting detailed trip and cost savings reports to a fleet manager.

10. The method of claim 1, wherein recursively analyzing the route further comprises:
determining a next intermediate fueling station by selecting a station with a lowest unburdened fuel cost within a maximum distance threshold from a current intermediate fueling station.

11. A fuel optimization system for long-haul trucking, the system comprising:
a database storing:—route data indicating a starting point and a final destination for a long-haul trucking route; and—fueling station data including locations and fuel prices for fueling stations along the route;
one or processors coupled to a memory configured to:
1. recursively analyze the route to determine a next stop and corresponding fuel quantity for each leg of the route based on:
1. a current fuel level;
2. an unburdened fuel cost at each fueling station, the unburdened fuel cost excluding one or more taxes and one or more discounts; and
3. a minimum fuel level to be maintained;
2. generate, based on analyzing the route, a fueling recommendation indicating:
1. one or more fueling stations at which to stop; and
2. a quantity of fuel to purchase at each of the one or more fueling stations;
3. collect trip details associated with the route; and
3. generate an International Fuel Tax Agreement (IFTA) report based on the trip details to facilitate obtaining an IFTA refund; and
a communication module configured to transmit the fueling recommendation to a driver device.

12. The fuel optimization system of claim 11, wherein the one or processors are further configured to:
determine an unburdened fuel cost at each fueling station by excluding one or more taxes from the fuel price; and
select the one or more fueling stations for the fueling recommendation based on the unburdened fuel cost.

13. The fuel optimization system of claim 11, wherein the one or processors are further configured to recursively analyze the route by:
determining if a current fuel level is sufficient to reach the final destination;
if the final destination cannot be reached, identifying a target fueling station with a lowest unburdened fuel cost; and
recursively analyzing a first leg from the starting point to the target fueling station and a second leg from the target fueling station to the final destination.

14. The fuel optimization system of claim 11, wherein the one or processors are configured to generate the fueling recommendation based on one or more of:
a truck miles per gallon (MPG);
a truck fuel tank size;
a current amount of fuel in the truck; and
a desired minimum amount of fuel to maintain as a reserve.

15. The fuel optimization system of claim 11, wherein the one or processors are further configured to:
discard a fueling station from consideration in the fueling recommendation if the fueling station is less than a minimum distance away from a previous fueling station; and
discard a fueling station from consideration in the fueling recommendation if reaching the fueling station consumes less than a minimum amount of fuel from a previous fueling station.

16. The fuel optimization system of claim 11, wherein the trip details collected by the one or more processors include one or more of:
total miles driven;
miles driven in each jurisdiction;
fuel purchased in each jurisdiction; and
fuel taxes paid in each jurisdiction.

17. The fuel optimization system of claim 11, wherein the communication module is further configured to:
transmit real-time alerts to the driver device indicating when to stop at the one or more fueling stations; and
transmit the IFTA report to a fleet manager device.

18. The fuel optimization system of claim 11, wherein one or processors are further configured to integrate the system with an existing fleet management platform via an application programming interface (API).

19. The fuel optimization system of claim 11, wherein the database further stores:
driver data indicating available hours of service for a driver; and
vehicle data indicating a current load of a vehicle, wherein one or processors are further configured to generate the fueling recommendation based on the driver data and the vehicle data.

20. The fuel optimization system of claim 11, wherein one or processors are further configured to:
continuously update the fueling recommendation based on real-time changes in fuel prices at the fueling stations; and
transmit the updated fueling recommendation to the driver device via the communication module.
